(19) United States
(12) Patent Application Publication
(10) Pub. No.: US 2009/0045311 A1
(43) Pub. Date: Feb. 19, 2009

(54) Multi-purpose, free-standing, portable, laptop computer or display object 360-degree swivel base assembly

(76) Inventor: Reza Seyedin, Singer Island, FL (US)

Correspondence Address: Reza Seyedin, 1220 Gulfstream Way, Singer Island, FL, 33404, US

(21) Appl. No.: 11/838,849

(22) Filed: Aug. 14, 2007

(51) Int. Cl. F16M 11/14

(52) U.S. Cl. 248/349.1

(57) ABSTRACT

A multi-purpose, free-standing, portable, swivel base assembly for laptop computers or other display objects includes a race-base formed by a circular groove on the top of the race-base and corresponding circular groove on the underside of a race-top that permanently locks into the race-base, encasing a rolling mechanism, permitting the race-top to swivel 360 degrees around the race-base.

Bumpers are added to the top side of the race-top to support the laptop computer or other display object while allowing for air circulation. Support pads are on the bottom side of the race-base to support and cushion the race-base in relation with respect to a tabletop.

### BACKGROUND OF THE INVENTION

1. Field of the Invention

This invention has relation to swivel assemblies which can be situated between laptop computers or other display objects and the tops of tables or a horizontally flat surface and which will then permit the object to swivel about a vertical axis.

2. Description of the Prior Art

In the placement of a laptop computer or other display object, it is desirable to effect rotation thereof so as to present different portions to view.

A number of rotatable stands have been developed which are adapted to permit rotation of the object carried thereby. Where the object is a laptop computer or other display object, it is desirable for a lightweight, compact and portable swivel base to effectively swivel the laptop computer or other display object 360 degrees for view-sharing of information or different angles of display object when desired. It further necessitates permission of adequate airflow to keep the laptop computer, or other display object that requires staying cool while in use, cool.

The known laptop computer stands do not fully satisfy the above requirements and have the further disadvantage of relatively large size, high cost, maintenance requirements and not providing adequate airflow.

What is needed is a multi-purpose, affordable, free-standing, lightweight, portable 360-degree swivel base assembly which can be acquired by a consumer to place under a laptop computer or other display object to permit 360-degree rotation for view-sharing of information or different angles of display object when desired.

### SUMMARY OF THE INVENTION

A multi-purpose, portable and free-standing swivel base assembly for supporting a laptop computer or other display object for 360-degree rotation movement with respect to a horizontal surface about a vertical laptop computer or other display object swivel axis.

The swivel base assembly includes a race-base formed by a circular groove on the top of the race-base and corresponding circular groove on the underside of a race-top that permanently locks into the race-base, encasing a rolling mechanism, permitting the race-top to swivel 360 degrees around the race-base.

Support bumpers are on the top side of the race-top to support the laptop computer or other display object while allowing for air circulation to keep the laptop computer or other display object cool. Support pads are fixed to the bottom side of the race-base to support and cushion the race-base in relation with respect to a tabletop.

The swivel base assembly could include an additional platform, attached to the race-top for color enhancement, aesthetic value and to provide a space for imprinting, such as, but not limited to advertising, photographs, art reproductions, etc.

### BRIEF DESCRIPTION OF THE DRAWINGS

FIG. 1 is an exploded perspective view illustrating the major components of the invention with ball-bearing assembly retainer;

FIG. 2 is a top, cross section and bottom view of the invention with ball-bearing assembly retainer;

FIG. 3 is a cross section view of the invention in a different configuration with ball-bearing assembly retainer;

FIG. 4 is an exploded perspective view illustrating the major components of the invention with plurality of ball-bearings;

FIG. 5 is a top, cross section and bottom view of the invention with plurality of ball-bearings;

FIG. 6 is a cross section view of the invention in a different configuration with plurality of ball-bearings;

FIG. 7 is an exploded perspective view illustrating the major components of the invention with roller-bearing assembly retainer;

FIG. 8 is a top, cross section and bottom view of the invention with roller-bearing assembly retainer;

FIG. 9 is a cross section view of the invention in a different configuration with roller-bearing assembly retainer;

FIG. 10 is an exploded perspective view illustrating the major components of the invention with plurality of roller-bearings;

FIG. 11 is a top, cross section and bottom view of the invention with plurality of roller-bearings;

FIG. 12 is a cross section view of the invention in a different configuration with plurality of roller-bearings;

FIG. 14 is an exploded perspective view illustrating the major components of the invention with ball-bearing assembly retainer, four corners of race-top and race-base extended and platform;

FIG. 15 is a top, cross section and bottom view of the invention with ball-bearing assembly retainer, four corners of race-top and race-base extended and platform;

FIG. 16 is an exploded perspective view illustrating the major components of the invention with plurality of ball-bearings, four corners of race-top and race-base extended and platform;

FIG. 17 is a top, cross section and bottom view of the invention with plurality of ball-bearings, four corners of race-top and race-base extended and platform;

FIG. 18 is an exploded perspective view illustrating the major components of the invention with roller-bearing assembly retainer, four corners of race-top and race-base extended and platform;

FIG. 19 is a top, cross section and bottom view of the invention with roller-bearing assembly retainer, four corners of race-top and race-base extended and platform;

FIG. 20 is an exploded perspective view illustrating the major components of the invention with plurality of roller-bearings, four corners of race-top and race-base extended and platform;

FIG. 21 is a top, cross section and bottom view of the invention with plurality of roller-bearings, four corners of race-top and race-base extended and platform;

### DETAILED DESCRIPTION OF THE INVENTION

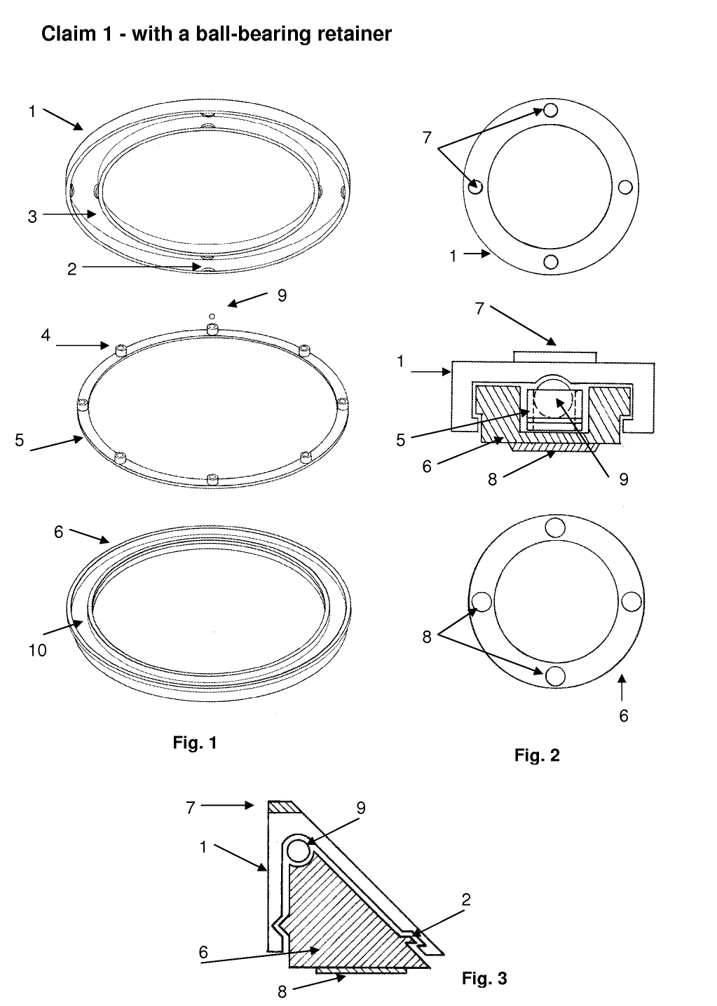

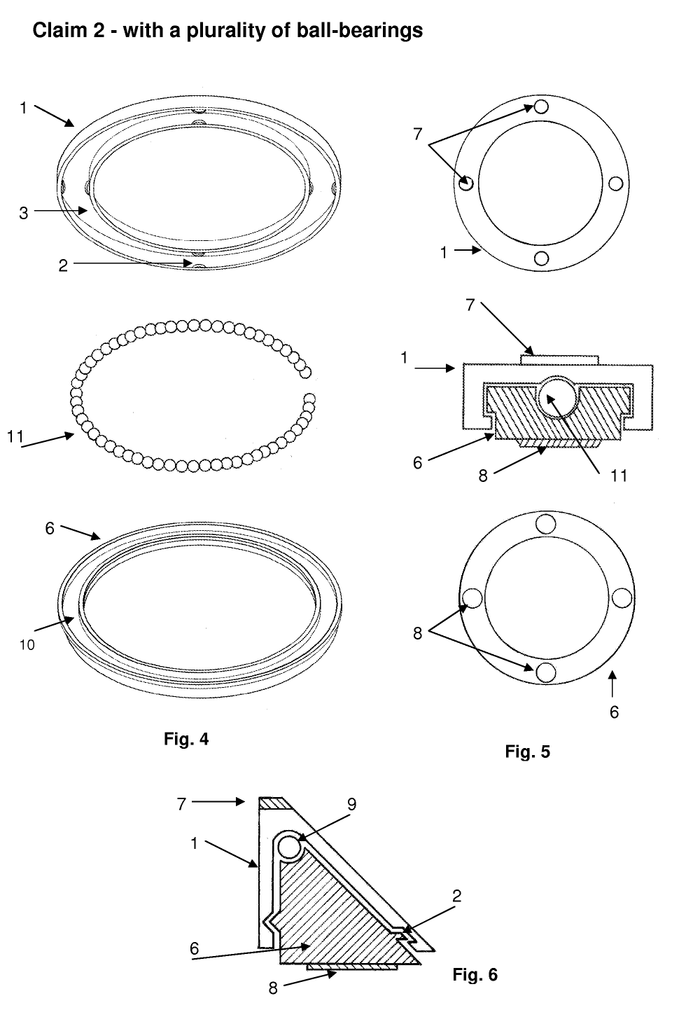

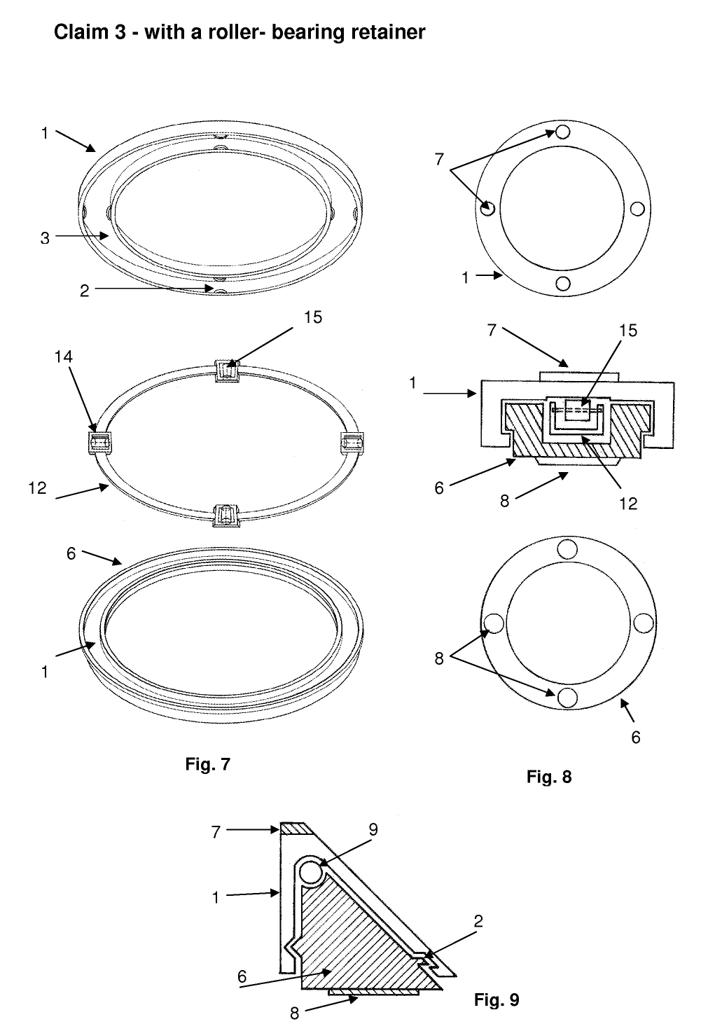

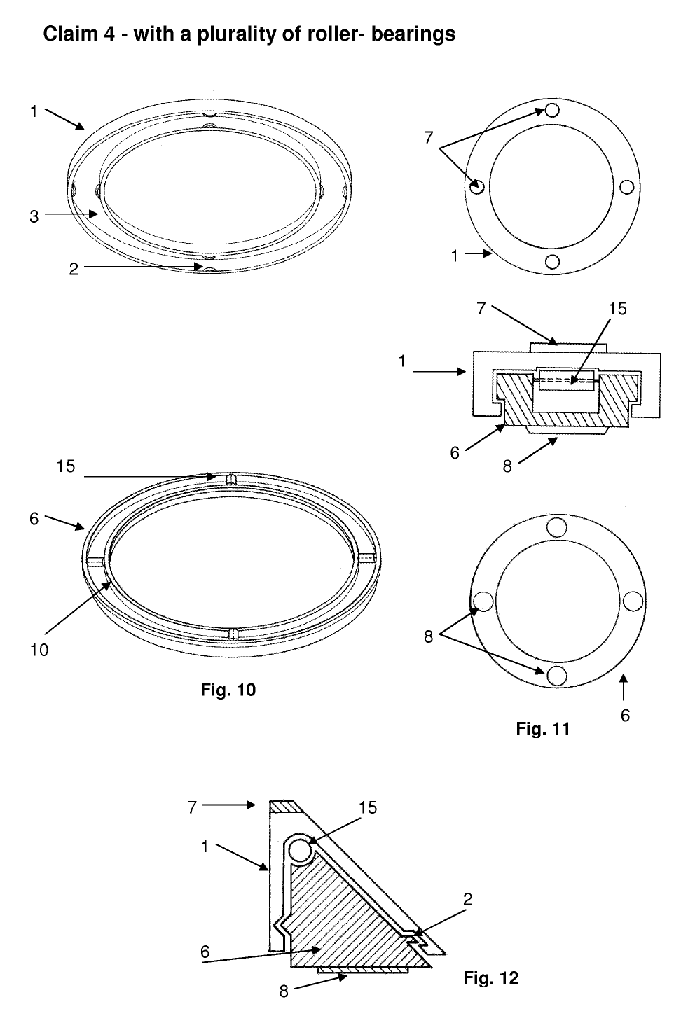

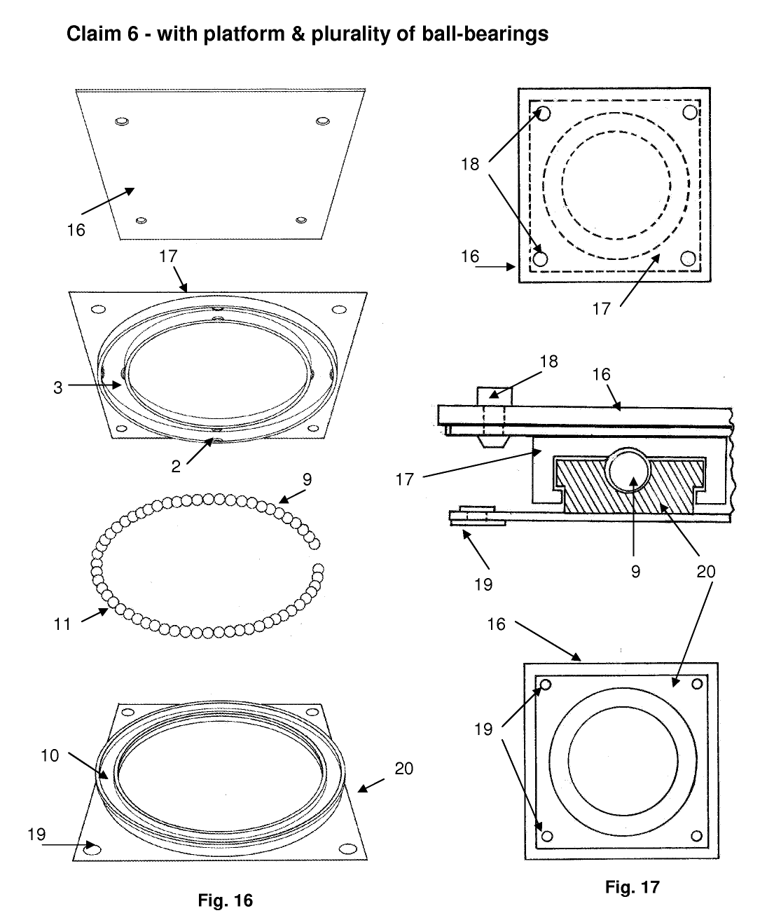

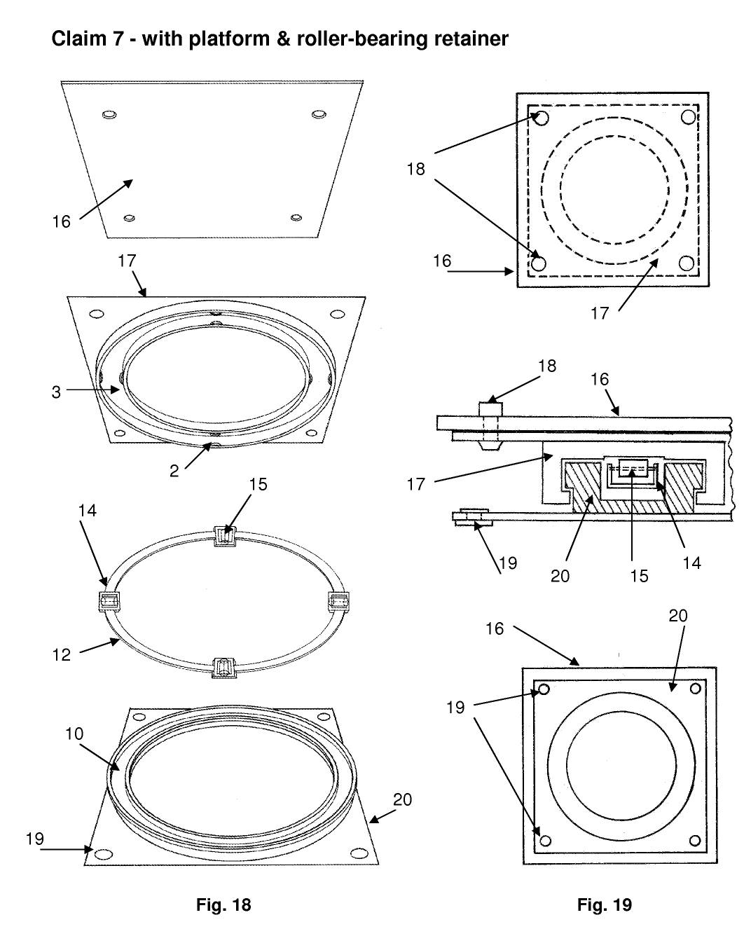

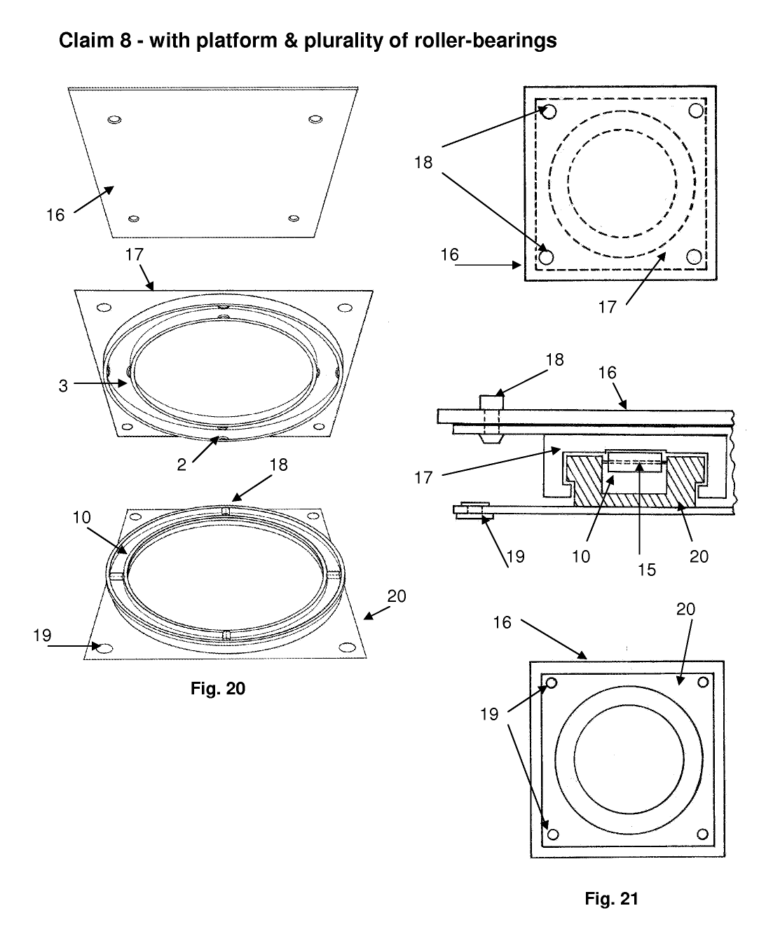

A multi-purpose, free-standing, portable, laptop computer or other display object 360-degree swivel base assembly of the present invention as seen in FIGS. 1 through 21.

FIGS. 1 through 21 are different design configurations, applications, materials and fabrications of the invention. Each claim includes a race-top 1 or 17, a race-base 6 or 20 and a bearing assembly 5, 11, 12 or 15.

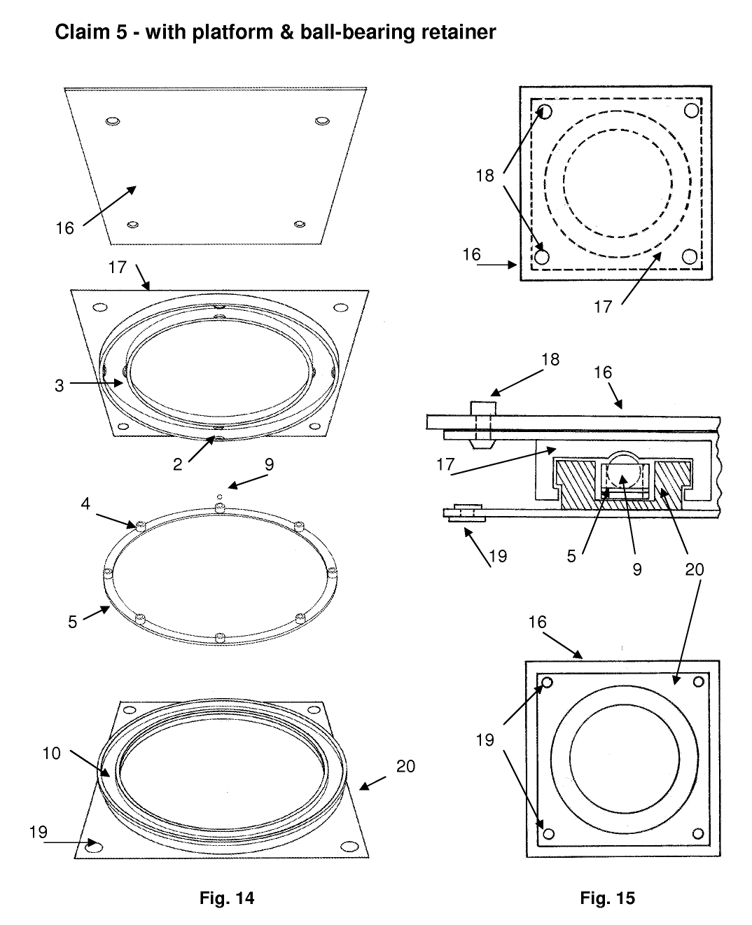

FIGS. 14 through 21, although substantially the same as FIGS. 1 through 12, include the four corners of the race-top 17 and race-base 20 extended in these configurations, to receive a platform 16 that is fastened to the race-top 17 with four bumpers 18. In these configurations, the race-top 1 is now indicated as race-top 17, and race-base 6 is now indicated as race-base 20.

FIGS. 3, 6, 9, and 12 are cross-sections of different variations of design configuration of the invention, as the race-top 1 and race-base 6 are modified designs in a triangular shape.

The bearing assembly 5, 11, 12 or 15 includes a plurality of ball-bearings 9 or roller-bearings 15 and/or ball-bearing housings 4 or roller-bearing housings 14 in evenly spaced relation to each other around the ball-bearing retainer assembly ring 5 or roller-bearing retainer assembly ring 12.

The race-base 6 or 20 with groove 10 houses the bearing assembly 5, 11, 12 or 15. The configuration of the bearing assembly 5, 11, 12 or 15 is such that it fits substantially within the race-base 6 or 20 with top portions of the ball-bearings 9 or roller-bearing 15 extending outwardly of the race-base groove 10. The race-top 1 or 17 is then coupled with the race-base 6 or 20 with a plurality of locking tabs 2 in such configuration that sandwiches the bearing assembly 5, 11, 12, or 15 within the race-top 1 or 17 groove 3 and the race-base 6 or 20 groove 10 while allowing the race-top 1 or 17 to freely swivel 360-degrees in either direction around the race-base 6 or 20. A plurality of bumpers 7 or 18 are added to the race-top 1 or 17. A laptop computer or other display object can be placed on the race-top 1 or 17 or platform 16 and can be swiveled as the race-top swivels with respect to the horizontal surface or tabletop. The bumpers 7 or 18 create sufficient space in relation to a laptop computer or other display object bottom positioned on the race-top 1 or 17, allowing for air circulation.

As seen in FIGS. 2, 3, 5, 6, 8, 9, 11, 12 and 14 through 21, support pads 8 or 19 are affixed to the bottom of race-base 6 or 20 to support and cushion the race-base 6 or 20 in relation to a horizontal surface or tabletop.

Although the present invention has been described with reference to preferred embodiments, workers skilled in the art will recognize that changes may be made in form and detail without departing from the spirit and scope of the invention. It is also to be understood that the words which have been used are words of description rather than limitation and that changes may be made within the purview of the appended claims without departing from the true scope and spirit of the invention in its broader aspects.

What is claimed is:

1. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a ball-bearing race-base having an annular, bearing race track formed by a circular groove on the top of the race-base to house a ball-bearing retainer assembly;
b. A race-top—an annular platform, positioned in supportive relationship under a laptop computer or other display object with a matching circular groove on the underside to house a ball-bearing assembly in such a configuration that when coupled with the race-base, permits the race-top to swivel 360 degrees around the race-base. The race-top is also constituted as a platform for a laptop computer or other display object for swiveling and rotation movement;
c. A ball-bearing assembly—includes a plurality of ball-bearings, a plurality of bearing cages and an annular retainer. The retainer to accommodate a plurality of bearing cages each encompassing a central portion of one of the bearings while leaving the top and bottom portions of the bearings exposed and a circular retaining ring integral with each of the cages and supporting the cages in evenly spaced relation to each other around the retainer ring;
d. The ball-bearing assembly, being of configuration such that the bearing retainer fits substantially within the race-base groove which is uppermost in a particular configuration with top portions of the bearings extending outwardly farther than the race-base;
e. The race-top and race-base are coupled together being of configuration such that the race-top snaps over the race-base, encasing the ball-bearing assembly, while permitting the race-top to swivel 360 degrees around the race-base;
f. The race-base carries support pads extending outwardly from its bottom side far enough to support and cushion the race-base in relation to a horizontal surface when the bottom side is down;
g. The race-top carries support bumpers extending outwardly from its top side far enough to support the laptop computer or display object, allowing space between the race-top and laptop computer or display object for increased air circulation.

2. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a ball-bearing race-base having an annular, bearing race track formed by a circular groove on the top of the race-base to house a plurality of ball-bearings when coupled with the race-top;
b. A race-top—an annular platform, positioned in supportive relationship under a laptop computer or other display object with a matching circular groove on the underside to house a plurality of ball-bearings in such a configuration that when coupled with the race-base, permits the race-top to swivel 360 degrees around the race-base. The race-top is also constituted as a platform for a laptop computer or other display object for swiveling and rotation movement;
c. Ball-bearings—a plurality of ball-bearings fits substantially within the race-base groove in a particular configuration with top portions of the ball-bearings extending outwardly farther than the race-base;
d. The race-top and race-base are coupled together being of configuration such that the race-top snaps over the race-base, encasing the plurality of ball-bearings, while permitting the race-top to swivel 360 degrees around the race-base;
e. The race-base carries support pads extending outwardly from its bottom side far enough to support and cushion the race-base in relation to a horizontal surface when the bottom side is down;
f. The race-top carries support bumpers extending outwardly from its top side far enough to support the laptop computer or other display object, allowing space between the race-top and laptop computer or other display object for increased air circulation.

3. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a roller-bearing race-base having an annular, bearing race track formed by a circular groove on the top of the race-base to house a roller-bearing retainer assembly;
b. A race-top—an annular platform, positioned in supportive relationship under a laptop computer or other display object with a matching circular groove on the underside to house a roller-bearing retainer assembly in such a configuration that when coupled with the race-base, permits the race-top to swivel 360 degrees around the race-base. The race-top is also constituted as a platform for a laptop computer or other display object for swiveling and rotation movement;
c. A roller-bearing assembly—includes a plurality of roller-bearings, a plurality of bearing cages and an annular retainer. The retainer to accommodate a plurality of bearing cages each encompassing a central portion of one of the bearings while leaving the top and bottom portions of the bearings exposed and a circular retaining ring integral with each of the cages and supporting the cages in evenly spaced relation to each other around the retainer ring;
d. The roller-bearing assembly, being of configuration such that the bearing retainer fits substantially within the race-base groove which is uppermost in a particular configuration with top portions of the bearings extending outwardly farther than the race-base;
e. The race-top and race-base are coupled together being of configuration such that the race-top snaps over the race-base, encasing the roller-bearing assembly, while permitting the race-top to swivel 360 degrees around the race-base;
f. The race-base carries support pads extending outwardly from its bottom side far enough to support and cushion the race-base in relation to a horizontal surface when the bottom side is down;
g. The race-top carries support bumpers extending outwardly from its top side far enough to support the laptop computer, allowing space between the race-top and laptop computer or other display object for increased air circulation.

4. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a roller-bearing race-base having an annular, bearing race track formed by a circular groove on the top of the race-base to house a plurality of roller-bearings when coupled with the race-top;
b. A race-top—an annular platform, positioned in supportive relationship under a laptop computer or other display object with a matching circular groove on the underside to house a plurality of roller-bearings in such a configuration that when coupled with the race-base, permits the race-top to swivel 360 degrees around the race-base. The race-top is also constituted as a platform for a laptop computer or other display object for swiveling and rotation movement;
c. Roller-bearings—a plurality of roller-bearings fits substantially within the race-base groove in a particular configuration with top portions of the roller-bearings extending outwardly farther than the race-base;
d. The race-top and race-base are coupled together being of configuration such that the race-top snaps over the race-base, encasing the plurality of roller-bearings, while permitting the race-top to swivel 360 degrees around the race-base;
e. The race-base carries support pads extending outwardly from its bottom side far enough to support and cushion the race-base in relation to a horizontal surface when the bottom side is down;
f. The race-top carries support bumpers extending outwardly from its top side far enough to support the laptop computer or other display object, allowing space between the race-top and laptop computer or other display object for increased air circulation.

5. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a ball-bearing race-base having an annular, bearing race track formed by a circular groove on the top of the race-base to house a ball-bearing retainer assembly. Four corners of the race-base are extended outward forming a square to allow for support in relation to this configuration;
b. A race-top—an annular platform, positioned in supportive relationship under a laptop computer or other display object with a matching circular groove on the underside to house a ball-bearing retainer assembly in such a configuration that when coupled with the race-base, permits the race-top to swivel 360 degrees around the race-base. Four corners of the race-top are also extended outward forming a square, to allow for support of an additional platform;
c. A ball-bearing assembly—includes a plurality of ball-bearings, a plurality of bearing cages and an annular retainer. The retainer to accommodate a plurality of bearing cages each encompassing a central portion of one of the bearings while leaving the top and bottom portions of the bearings exposed and a circular retaining ring integral with each of the cages and supporting the cages in evenly spaced relation to each other around the retainer ring;
d. The ball-bearing assembly, being of configuration such that the bearing retainer fits substantially within the race-base groove which is uppermost in a particular configuration with top portions of the bearings extending outwardly farther than the race-base;
e. The race-top and race-base are coupled together being of configuration such that the race-top snaps over the race-base, encasing the ball-bearing assembly, while permitting the race-top to swivel 360 degrees around the race-base;
f. Platform—a platform is attached by bumpers to the top side of the race-top for color enhancement, aesthetic value and to provide a space for imprinting, such as, but not limited to advertising, photographs, art reproductions, etc.;
g. The race-base carries support pads extending outwardly from its bottom side far enough to support and cushion the race-base in relation to a horizontal surface when the bottom side is down;
f. The race-top carries support bumpers extending outwardly from its top side far enough to support the laptop computer or other display object, allowing space between the platform and laptop computer or other display object for increased air circulation.

6. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a ball-bearing race-base having an annular, bearing race track formed by a circular groove on the top of the race-base to house a plurality of ball-bearings when coupled with the race-top. Four corners of the race-base are extended outward forming a square to allow for support in relation to this configuration;
b. A race-top—an annular platform, positioned in supportive relationship under a laptop computer or other display object with a matching circular groove on the underside to house a plurality of ball-bearings in such a configuration that when coupled with the race-base, permits the race-top to swivel 360 degrees around the race-base. Four corners of the race-top are also extended outward forming a square, to allow for support of an additional platform;
c. Ball-bearings—a plurality of ball-bearings fits substantially within the race-base groove in a particular configuration with top portions of the ball-bearings extending outwardly farther than the race-base;
d. The race-top and race-base are coupled together being of configuration such that the race-top snaps over the race-base, encasing the plurality of ball-bearings, while permitting the race-top to swivel 360 degrees around the race-base;
e. Platform—a platform is attached by bumpers to the top side of the race-top for color enhancement, aesthetic value and to provide a space for imprinting, such as, but not limited to advertising, photographs, art reproductions, etc.;
f. The race-base carries support pads extending outwardly from its bottom side far enough to support and cushion the race-base in relation to a horizontal surface when the bottom side is down;
g. The race-top carries support bumpers extending outwardly from its top side far enough to support the laptop computer or other display object, allowing space between the platform and laptop computer or other display object for increased air circulation.

7. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a roller-bearing race-base having an annular, bearing race track formed by a circular groove on the top of the race-base to house a roller-bearing retainer assembly. Four corners of the race-base are extended outward forming a square to allow for support in relation to this configuration;
b. A race-top—an annular platform, positioned in supportive relationship under a laptop computer or other display object with a matching circular groove on the underside to house a roller-bearing retainer assembly in such a configuration that when coupled with the race-base, permits the race-top to swivel 360 degrees around the race-base. Four corners of the race-top are also extended outward forming a square, to allow for support of an additional platform;
c. A roller-bearing assembly—includes a plurality of roller-bearings, a plurality of bearing cages and an annular retainer. The retainer to accommodate a plurality of bearing cages each encompassing a central portion of one of the bearings while leaving the top and bottom portions of the bearings exposed and a circular retaining ring integral with each of the cages and supporting the cages in evenly spaced relation to each other around the retainer ring;
d. The roller-bearing assembly, being of configuration such that the bearing retainer fits substantially within the race-base groove which is uppermost in a particular configuration with top portions of the bearings extending outwardly farther than the race-base;
e. The race-top and race-base are coupled together being of configuration such that the race-top snaps over the race-base, encasing the roller-bearing assembly, while permitting the race-top to swivel 360 degrees around the race-base;
f. Platform—a platform is attached by bumpers to the top side of the race-top for color enhancement, aesthetic value and to provide a space for imprinting, such as, but not limited to advertising, photographs, art reproductions, etc.;
g. The race-base carries support pads extending outwardly from its bottom side far enough to support and cushion the race-base in relation to a horizontal surface when the bottom side is down;
f. The race-top carries support bumpers extending outwardly from its top side far enough to support the laptop computer or other display object, allowing space between the platform and laptop computer or other display object for increased air circulation.

8. A multi-purpose, free-standing, portable, swivel base assembly for laptop computers or other display objects for 360-degree rotation movement with respect to a horizontal tabletop about a vertical laptop computer or other display object swivel axis, the swivel base assembly including:
a. A race-base—a roller-bearing race-base having an annular, bearing race track formed by a circular groove on the top of the race-base to house a plurality of roller-bearings when coupled with the race-top. Four corners of the race-base are extended outward forming a square to allow for support in relation to this configuration;
b. A race-top—an annular platform, positioned in supportive relationship under a laptop computer or other display object with a matching circular groove on the underside to house a plurality of roller-bearings in such a configuration that when coupled with the race-base, permits the race-top to swivel 360 degrees around the race-base. Four corners of the race-top are also extended outward forming a square, to allow for support of an additional platform;
c. Roller-bearings—a plurality of roller-bearings fits substantially within the race-base groove in a particular configuration with top portions of the roller-bearings extending outwardly farther than the race-base;
d. The race-top and race-base are coupled together being of configuration such that the race-top snaps over the race-base, encasing the plurality of roller-bearings, while permitting the race-top to swivel 360 degrees around the race-base;
e. Platform—a platform is attached by bumpers to the top side of the race-top for color enhancement, aesthetic value and to provide a space for imprinting, such as, but not limited to advertising, photographs, art reproductions, etc.;
f. The race-base carries support pads extending outwardly from its bottom side far enough to support and cushion the race-base in relation to a horizontal surface when the bottom side is down;
g. The race-top carries support bumpers extending outwardly from its top side far enough to support the laptop computer or other display object, allowing space between the platform and laptop computer or other display object for increased air circulation.
